(19) United States
(12) Patent Application Publication
(10) Pub. No.: US 2014/0272440 A1
(43) Pub. Date: Sep. 18, 2014

(54) Transfer Foils Utilizing Plasma Treatment to Replace the Release Layer

(71) Applicant: ILLINOIS TOOL WORKS INC., Glenview, IL (US)

(72) Inventors: William A. Herring, Valpariso, IN (US); Suwit J. Sangkaratana, Crown Point, IN (US); John H. Schneider, Frankfort, IL (US)

(21) Appl. No.: 13/842,548

(22) Filed: Mar. 15, 2013

(51) Int. Cl. B41M 3/12; B01J 19/08

(52) U.S. Cl. CPC B41M 3/12; B01J 19/088
USPC 428/457; 427/535

(57) ABSTRACT

A method providing for the replacement of the traditional release layer of transfer foils uses a plasma treatment to chemically modify the foil side surface of a PET substrate of the transfer foils. The chemically modified surface of the PET substrate provides the necessary low surface energy and release characteristics to allow for the controlled release of the foil from the PET carrier film. Accordingly, plasma treated transfer foils can be made without a release layer.

### TECHNICAL FIELD

The exemplary teachings herein pertain to transfer foils for application on a substrate, and to methods and techniques of making these transfer foils. Specifically, the present disclosure relates to a method and use of a plasma treatment to replace the traditional coated release layer of these transfer foils, and to the products made by the methods and techniques.

### BACKGROUND

Plasma treatment of various surfaces for various purposes is generally known. Further, there are different types of plasma treatments. Air or atmospheric plasma treatment is a surface modification technique that uses a low temperature corona discharge, generated by the application of high voltage to sharp electrode tips, to impart changes in the properties of a surface. If the atmosphere at the point of discharge is simply air (mainly nitrogen & oxygen), the process is generally termed corona treatment. Flame plasma treatment involves the use of burning flammable gas to modify a surface through the distribution electrons in an oxidation form. Chemical plasma treatment is a surface modification technique that involves depositing various chemical groups onto a surface to modify its properties and/or characteristics. This process is often conducted in a vacuum chamber where the air has been removed and gases or vapors are introduced into the discharge area. In most cases these methods are employed to alter the surface of a plastic film or part to increase the surface energy of the surface being treated for enhanced wet out and adhesion of subsequent printing or wet coatings to be applied to that surface (i.e., packaging films, painted parts, etc.).

Release coatings in transfer foils are typically used to aid in the transfer of the foil coating package to a substrate during the foiling process, as may be used for example for products such as gift cards, plastic parts, credit cards, packaging, etc. The release coatings are coated directly to the PET or other plastic carrier film of the transfer foils prior to the coating of the topcoat or pigment coat. Typically, release coats have a low surface energy and are formulated to allow for the controlled release of the foil coating package from the carrier film under a given heat and pressure.

A typical transfer foil is illustrated in FIG. 1. As can be seen in FIG. 1, the transfer foil comprises a carrier film, a release coat applied to the carrier film, a top coat or pigment coat applied to the release coat, an optional metal layer attached to the top coat, and a size layer attached to the metal layer (or to the top coat when the metal layer is not present). The release layer, top coat, metal layer (if present) and size layer collectively comprise the foil coating package of the standard transfer foil. Thus, in a conventional transfer foil, the release layer is transferred along with or as part of the foil coating package that is applied to the substrate being foiled.

During the foiling process, the transfer foils are brought into contact with a substrate being foiled, for example, between lamination rollers or under a stamping die, whereupon heat and pressure are applied and the release coating releases from the carrier film along with top coat or pigment coat, the metal layer (if present) and the size layer where it then adheres/transfers to the substrate.

Release coats are most commonly applied to the carrier film by a coating station and involve the use of solvents or water which subsequently must be evaporated, and the coating layer allowed to dry. This process utilizes both time and resources during the manufacturing process of the transfer foils.

Therefore, a need exists for an improved method of making transfer foils, which is directed toward overcoming these and other disadvantages of prior art methods. Accordingly, to address the above stated issues, an improved method to allow for the controlled release of the foil from the carrier film, while providing ease of manufacturing and cost savings, is needed. The exemplary teachings herein fulfill such a need. It is desired that the methods and techniques for providing the above benefits be applicable to any instances or applications wherein a release coat for a lamination process or similar process is needed.

### SUMMARY

The exemplary technique(s), system(s) and method(s) presented herein provide for the replacement or elimination of the release layer, through the use of a chemical plasma treatment applied to the PET or other plastic carriers of the transfer foils. The plasma treatment chemically modifies the surface of the carrier film such that the traditional release coat is not necessary. The chemically modified surface of the carrier provides the necessary low surface energy and proper release characteristic properties to facilitate the controlled release of the foil coating package from the carrier film. This plasma treatment of the carrier film thus eliminates the need for the release layer, for any coating equipment used to apply the release layer, and for the time and resources used to evaporate the solvents or water during the manufacturing process.

Additional objects, advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawing figures depict one or more implementations in accordance with the present teachings, by way of example only, not by way of limitation. In the drawing figures, like reference numerals refer to the same or similar elements.

FIG. 1 is a schematic cross-sectional illustration of a prior art, standard transfer foil; and

FIG. 2 is a schematic cross-sectional illustration of an exemplary embodiment of a transfer foil having been plasma treated according to the present disclosure.

### DETAILED DESCRIPTION

The following description refers to numerous specific details which are set forth by way of examples to provide a thorough understanding of the relevant teachings. It should be apparent to those skilled in the art that the present teachings may be practiced without such details. In other instances, well known methods, procedures, and components have been described at a relatively high-level, without detail, in order to avoid unnecessarily obscuring aspects of the present teachings.

Referring now to FIG. 2, a transfer foil incorporating the teachings of the present disclosure is illustrated. Specifically, the transfer foil of the present disclosure includes a PET or other plastic carrier film having a surface which has been chemically modified by a plasma treatment, as illustrated schematically by the row of dots in FIG. 2, a top coat or pigment coat applied to the plasma treated surface of the carrier film, an optional metal layer attached to the top coat, and a size layer attached to the metal layer (or to the top coat when the metal layer is not present). The top coat, metal layer (if present) and size layer collectively comprise the foil coating package layer of the transfer foil. As there is no release layer in the transfer foil, there is no transfer of any release layer to the substrate being foiled as part of the foil coating package.

Most of the gases and vapors that can and have been introduced into the corona discharge region of a plasma treater will increase the surface energy of the continuous web (plastic or paper carrier) or part for enhanced wet out and adhesion. The many gases used include oxygen, argon, carbon dioxide, acetylene, other hydrocarbon-based gases, ammonia and other nitrogen containing gases. In order to reduce the surface energy of a surface via plasma one must use less conventional gaseous & vapor species that will form radicals and deliver chemistries onto the surface of the carrier or part that will impart release and heat resistant characteristics. These materials would include chemistries involving fluorinated materials, silicones, methylsiloxanes, olefinics and the like. Some of these items may already exist in a gaseous phase at room temperature, while others may require pre-heating to yield the vapor form of the liquid species in order to convey it into the corona/plasma discharge area.

Accordingly, during the foiling process, the chemically modified surface of the carrier provides the necessary low surface energy and other proper release characteristic properties to allow for the controlled release of the foil coating package from the carrier film, without the need for the traditional wet coated release layer. Utilizing plasma treatment to chemically modify the foil side of the carrier film can lower the cost of transfer foils by eliminating the need for: the release layer, the use of one coating station, the needed drying equipment, and the subsequent evaporation of the solvents or water used to apply the release layer.

In addition, instead of using a coating station to apply a release layer, that coating station can now be used to coat an additional functional layer for enhancing the transfer foil. Examples include: increased abrasion resistance, surface or other color effects. As another example, the first coating station that is usually used to apply the release layer can now apply a topcoat. The coating station used to apply the topcoat can be used to apply another functional layer such as a tie layer to promote metal adhesion, or a tie layer with different functionality.

While the foregoing discussion presents the teachings in an exemplary fashion with respect to the disclosed methods and techniques for plasma treating transfer foils to replace the traditional release layer, and the products produced by the methods and techniques, it will be apparent to those skilled in the art that the teachings may apply to the plasma treatment of any type of substrate which has traditionally required a release layer. Further, while the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed is:

1. A transfer foil comprising:
a plastic carrier film for supporting and conveying a foil coating package layer, wherein the carrier has a foil side surface;
a foil coating package layer; and
a plasma treatment applied to the foil side surface of the plastic carrier.

2. The transfer foil of claim 1, wherein the plasma treatment chemically modifies the foil side surface of the film carrier to impart a low surface energy and proper release characteristics.

3. The transfer foil of claim 2, wherein the plasma treatment eliminates the need for a release coat on the foil side surface of the film carrier.

4. A process of producing a transfer foil without a release coat, comprising the step of:
plasma treating a foil side surface of a filmic carrier to impart a low surface energy and proper release characteristics to allow for the controlled release of a foil coating package layer without a need for a release coat.

5. The product made by the process of claim 4.
